(19) United States
(12) Patent Application Publication
(10) Pub. No.: US 2022/0144718 A1
(43) Pub. Date: May 12, 2022

(54) MULTILAYER WATER DISPERSIBLE FILM HAVING IMPROVED GERMINATION OF SEEDS AND SOIL FERTILITY

(71) Applicants: Atikullah Husenmiya SAIYAD, Gujarat (IN); Pradip Kumar Khodabhai PATEL, Gujarat (IN)

(72) Inventors: Atikullah Husenmiya SAIYAD, Gujarat (IN); Pradip Kumar Khodabhai PATEL, Gujarat (IN)

(21) Appl. No.: 17/378,485

(22) Filed: Jul. 16, 2021

(30) Foreign Application Priority Data
Nov. 10, 2020 (IN) 202021049064

(51) Int. Cl. C05G 3/40; C05G 5/30; C05G 5/40; C05G 3/90; C05G 3/60; C05G 1/00; C05C 9/02; A01N 25/34

(52) U.S. Cl. CPC C05G 3/44; C05G 5/37; C05G 5/40; A01N 25/34; C05G 3/60; C05G 1/00; C05C 9/02; C05G 3/90

(57) ABSTRACT

This invention relates to water-soluble/dispersible film system with embedded/entrapped water dispersible materials. Said invention discloses water dispersible film system with crop and vegetables seed strip with embedded/entrapped therein such as to provide precise and desired release of actives ingredients there from and its method of manufacturing for diverse applications, in which a variety of substances such as Fertilizers, Micronutrients, Organic fertilizer, Plant growth hormones, Bio-pesticides, Bioinsecticides, Bio fungicide, Organic Soil Conditioners, Plant growth promoter, Neem pesticides, Humicacid, Weed control (herbicide, preemergence herbicide) including treatments for the removal of dormancy. The invention further discloses novel online and offline process for the manufacture of such multi layered water dispersible film with or without liners and of desired shapes to selectively entrap interacting/non-interacting materials and their combinations.

### CROSS-REFERENCE TO RELATED APPLICATIONS

This application claims the benefit of Indian Application No. 202021049064, filed Nov. 10, 2020, in the Indian Patent Office. All disclosures of the document named above are incorporated herein by reference.

The following specification particularly describes the nature of the invention and the manner in which it is to be performed:

### FIELD OF THE INVENTION

The present invention relates to a method of improving germination of different crop seeds by encapsulation the seeds in multilayered water soluble/dispersible plastic film having an active ingredients.

### BACK GROUND OF THE INVENTION

The present invention relates to a method of improving germination of different crop seeds by encapsulation the seeds in multilayered water soluble/dispersible plastic film having an active ingredients. This film itself having hydrophilic properties so that seeds does not required hydration treatment prior to sowing. The encapsulated seeds in the present invented multi-layered film achieved rapid and uniform germination after sowing and improving germination rate even in an adverse environment. This invention relates form of a film of plastic and the use thereof in the agriculture or plant cultivation field. One of the important uses of the present invention is that, the serves effectively to establish conditions in and about cultivated soil which materially favor seed germination and plant growth.

More specifically, this invention, throughout the growing season, not only serves as an excellent source of plant nutrient material but also acts both to retard evaporation of soil moisture around the root system of plant and to increase soil temperature to promote seed germination. In addition, this multilayer biodegradable film functions to curtail weed growth and to reduce the incidence of damage to seeds and seedlings by biological agents. With the passage of time, this multilayer film disintegrates and may be mixed into the soil to make it an integral part thereof thereby eliminating any need for removing any component of the film or embody materials from the soil prior to normal pre-sowing soil cultivation operations. The environmental factor such as moisture, temperature, oxygen, light etc. are appropriate during the certain period of time of seeds germination process. Various metabolic process proceeds during the seeds during the germination period from sowing to germination. Getting rapid and uniform germination of seeds facilities cultivation management and commercial production. This will reduce the production cost and reduce labor. To enhance the germination process, generally hydration of seeds technology is widely used. In this technology the seeds are sowing by supplying them before sowing with water and treating them for a period of time and temperature sufficient to cause seeds to imbibe sufficient water to enhance resultant plant vigor but insufficient to cause seeds sporting. There are many hydration techniques reported in the literature, the following fever may be mention as follows.

Priming: W. heydecker et al in 1974 developed priming method. In this method osmotically controlled supply of water to seeds using aqueous solution of water-soluble polymers (poly ethylene glycol, sodium polypropionate etc. (W. heydecker, J. Higgins and R. L. Gulliver, 1973 Nature (London) 246:42-44., W. Heydencker 1974 Uni. Nottingham, Sch. Agr. Rep. 1973/1974:50-67, Zuo Weineng et al. 1987 Chines Science Bulletin 32:1438

Drum Priming: In British Patent 2192781 reported drum priming techniques which is comprising supplying seeds with water by spraying in a rotating drum to there by directly control the weight of water to be supplied to seeds without using any medium.

Solid Matrix Priming:

A. G. Taylor et al in 1986 developed this techniques controlling the water supply to seeds using as a medium, a pulverized leopardite shale material (Agro-Lig.) (A. G. Taylor, D. E. Lkein and T. H. Whtlow, 1988 Science, Horticulture 37(1988) 1-11 U.S. Pat. No. 4,912,874B1, WO88/07318) Oktav Aral et. Al in WO 03/088747 A1 described multilayered oriented film having antimicrobial and antifogging properties. This film composed core layer of semi and biaxial oriented polyolefin based antifogging.

CN 104334019 A described multilayered film capable of releasing active ingredients over limited time period for example pesticides. This film has a bottom or internal layer composed of water-soluble polymer fraction including active ingredients. While bottom or internal layer may have water soluble polymer fraction in addition to the water soluble polymer fraction. When this multilayered film exposed to humidity and/or exited condition this water insoluble layer produce pre-determined time of release of active ingredients. This patent also described the method on manufacturing the multilayer film and to uses of the same film.

U.S. Pat. No. 4,686,790, Aug. 18, 1987 disclose a plastic mulch film which has good mechanical properties, clarity, the ability to retard weed growth without the use of herbicides or black pigments, degradability, the incorporation of nutritional materials, slow release characteristics and which is safe for the environment and ecology because it does not include toxic chemicals. That film disintegrates over the course of a growing season and releases the necessary nutritional value to plants in a controlled manner.

U.S. Pat. No. 4,845,888 describe the method of manufacturing of multilayer film for control release of plant nutrients using poly vinyl alcohol and water resistant thermoplastic material like poly vinyl acetate to slow down the release of plant nutrients. This work also enclose the mechanical properties of deferent film with deferent ingredients. This patent also disclose the formulation of deferent layer for the biodegradable mulch film.

U.S. Pat. No. 3,698,133 disclosed the method and process of seeds coating with latex of polyvinyl chloride/polyvinylidene chloride, vinyl butral/acrylonitrile/methacrylic acid and ethyl acrylate/vinylidene chloride using plasticizer like diethyl phthalate.

U.S. Pat. No. 4,251,952 this patent describe the coating solution prepared from white glue acrylic copolymer, modified ethylene interpolymers, isocyanate as a prepolymer material. And sugar calcium carbonate as a coating ingredients for deferent seeds like rice and other. This patent also describe the germination of deferent seeds.

WO 99/57959 exposed the coating of seeds by polysaccharide material for deferent seeds, this film coating provide additional physiological benefits, like cold imbibition damage, the coated seeds retain its original shape and weight after coating.

WO 01/45489 describe the seed coating for improving the efficiency of plant nutrients and coated seeds by using biodegradable oil and molasses as a coating material with emulsifying agent work done on wheat seed.

US 20150157015A1 this patent concerned a method to increase the growth of plant by coating seed with composition comprising at least a cationic guar. This invention also relates a seed coating composition and such method.

US 005335449 A describe the delivery system for an agricultural active material like biocides such as insecticides, fungicides and others,

U.S. Pat. No. 3,947,996 describe the method of coating seeds to control germination and the resultant coated seeds.

WO 8404651 exposed the method of germination improving seed capsule and preparing the same.

EP 1 568 264 A1 describe the method for improving germination of hard seed by laser irradiation and germination improved seed.

US 2016/0029550 A1 describe portable hydro seeder, seed, and mulch and fertilizer water disposable packet. Here a portable hydro seeder having seed, mulch and fertilizer in predetermine ration. The seed mulch and fertilizer dissolve in a slurry when combine with water,

U.S. Pat. No. 6,446,386B1 and CN 0230922 disclose a seed germination medium comprising of an upper layer formed from a bio degradable material which is permeable to gases but impermeable to water or liquid, while lower layer from water absorbent biodegradable material. The upper layer of this film contains polyolefin like polyethylene, propylene etc. and lower layer contain poly vinyl alcohol as a binder, this invention is also disclosed the use of reinforcing material such as fibrous mat.

EP 0477514 A1 disclose a laminar seed carrier for light sensitive grains comprise a backing and covering strip both covered with adhesive. Here, polyvinyl alcohol base film is use with green dye in both the layer for covering of seeds.

WO 2011034262A1 describe direct seeding method of rice seed using biodegradable agricultural mulch film. This mulch film consisting of aliphatic polyester material having encapsulated calcium carbonate containing stearic acid.

U.S. Pat. No. 3,299,566 describe the method of manufacturing method of water-soluble film containing agricultural chemicals. This film is consisting of poly vinyl alcohol and poly ethylene oxide, the resulting film is perforated to admit air to the earth's surface. Michael Roger and at all in US 20080050433A1 describe water soluble film for realizing active ingredients, particularly plant protection products and plant growth promoting agents. The film comprising water soluble biodegradable material poly vinyl alcohol with insecticide of deferent %.

Otey et al. in U.S. Pat. No. 3,949,145 disclosed plastic film composition for agricultural mulch which will with stand outdoor weathering conditions for a desired time then rapidly disintegrate. This film comprise of starch, poly vinyl alcohol, glycerol and hydrophobic coating of poly vinyl chloride.

WO2015/118479 A1 describe the seed coating composition and their use for increase yield. Composition comprising styrene butadiene latex polymer and blend of poly ethylene with carnauba wax.

### OBJECTIVE OF THE INVENTION

The main objective of the present invention is to provide stable water dispersible film system (multilayer) having incorporated active ingredients and process for the manufacturing of the multilayer water soluble/dispersible plastic film and their wide application particularly in farming. This film provides ease of germination of varieties of seeds and propagate growth process of plants. This multilayer plastic film provides the micronutrients to the plant and in precise dosage. This film also provides organic liquid-fertilizer and/or chemical fertilizer at different stage of plant growth as the top layer of this multilayer water soluble/dispersible film itself contain urea-formaldehyde condensed resin, such resin which is not easily leaching wet soil.

Another objective of such invented multilayer film is to provide soil constructing materials in middle layer with plant nutrients.

Yet another objective of the present invention is to provide online/offline encapsulation of seeds with biodegradable thread (string) to provide extra strength to the encapsulated seed with multilayer water soluble/dispersible film. This thread provides reinforcement to the encapsulated plastic film.

Yet another objective of the present invention is to provide batch formulation of the different layer i.e. core layer, middle layer and top layer. These three (or more) layer having different properties as they contain different ingredients as per end use purposes.

Yet another objective of the present invention is to provide the process of the manufacturing multilayer water soluble/dispersible plastic film to selective entrapped interacting/no interacting materials.

Yet another objective of the present invention is providing a process of manufacturing water soluble/dispersible plastic film with material incorporated in selective area of the film.

Yet another objective of the present invention is providing the water soluble/dispersible film (WDF) for diverse application in which the variety of substances such as organic liquid fertilizer (Seaweed extract, Bacterial extract liquid fertilizer, organic humic fertilizer) chemical fertilizer, modified chemical fertilizer urea formaldehyde condensate product (UF), pesticides, insecticides, weedicide etc. incorporation for desire and precise dosage to the plant.

Yet another objective of the present invention is to provide a process for manufacturing of WDF exploiting the various incorporating materials of the invention using a wide range of raw materials including different range of poly vinyl alcohol, poly vinyl acetate, copolymer of poly vinyl acetate, copolymer of polyvinyl alcohol with acryl amide, acrylic acid, starch, ethylene glycol, polymethyl acrylate, poly vinyl pyrrolidone, and blend of poly vinyl alcohol with starch, poly acrylic acid, poly acrylamide, poly vinyl acetate, dextrin, and derivative of starch, proteinaceous binders such as gelatin modified gelatins such as phthaloyl gelatin, polysaccharides, such as starch, gum arabic and dextrin and water-soluble cellulose derivatives.

Yet another objective of the present invention is to provide a process for the manufacturing of water soluble/dispersible plastic film using carrier material like poly ester film of different micron, plastic coated paper, metalize paper, and metalize poly ester film, plastic coated fabric. This carrier materials either plan or embossed as per end use liner material may be single or combination of any or all of the materials. Liner may be used for either sing use or multiple use.

Yet another objective of the present invention is to provide a direct coating solution to seeds without using film.

Yet another objective of the present invention is to provide manufacturing process for water soluble film for packaging using material of core layer for solid agrochemicals, powder detergent, or any hazardous chemicals,

Yet another objective of the present invented film provides backing material for embroidery work using single film consisting of core layer.

Yet another objective invention is provide the process of encapsulation of seed with reinforcing material with present invented film.

Yet another objective of the present invention is to provide printable surface on both core and top layer by any convention printing machine, printing may be online or offline and may be with or without carrier film.

### SUMMARY OF THE INVENTION

This multilayered, composite, degradable/decomposable agricultural film according to the present invention have a number of important properties. For example, the degradable/decomposable agricultural film has good clarity, mechanical properties, good lower oxygen transmission rate (OTR) (Table-2), good degradability, the incorporation of nutritional materials, slow release of nutritional materials and safety to the environment and ecology and also good sealing and printing properties. In addition, the degradable/decomposable agricultural film can be tailored to a specific soil and crop so that the optimal amount of specific nutrients will be applied to the crop during the various stages of plant growth. Therefore, the use of the present multilayer film disclosed and claimed herein results in increased seed germination %, increase yield, earlier harvests, optimal use of fertilizer, increase plant growth (Table 2) and reduced labor. It is considered to be more economic to use than more conventional mulch and fertilizer programs. In compendium, the multi-layer degradable agricultural film includes a first or top layer which is formed from a water-soluble synthetic resin such as polyvinyl alcohol (both hot water and cold water soluble), methyl cellulose, and hydroxyethyl cellulose, blend of PVA with Starch or the like. The first layer also includes at least one releasable form of nitrogen such as urea or a water-soluble urea formaldehyde condensation product and at least one releasable plant nutrient such as, di ammonium phosphate, ammonium sulphate and NPK (Nitrogen-19, Phosphate-19, Potash-19). This first layer provides an initial amount of nutrient to a plant during the germination stage, preemergent and earlier emergent stages of growth. According to the present invention, a second layer formed as an adherent coating on the first layer. The second layer is form from a water-soluble synthetic resin such as polyvinyl alcohol (hot water soluble), methyl cellulose, hydroxyethyl cellulose and blend with polyvinyl acetate/poly acrylamide or the like. However, the water-soluble synthetic resin in the second layer has an average molecular weight which is greater than the average molecular weight of the water-soluble synthetic resin in the first layer and higher degree of hydrolysis. The second layer also includes at least one releasable form of nitrogen amalgamated therein, and a water-resistant polymer such as polyvinyl acetate as a blend with poly vinyl alcohol (hot water soluble) or the like to retard the degradation rate of the second layer and to slow the rate of release of the nitrogen. The second layer also includes organic liquid fertilizer material and zinc sulphate, ferrous sulphate as a soil constructing nutrients. In this way, the second layer provides the needed nutrients to a plant during the later stages of its growth. For some crops, it may be desirable to include at least one additional releasable plant nutrient Such as a water soluble NPK in the second layer. A multilayer film according to a preferred embodiment of the invention, also includes a third core layer. The core layer comprises a water-soluble synthetic resin such as a polyvinyl alcohol, methyl cellulose or hydroxyethyl cellulose, blend of PVA with Starch, wetting agents (surface active agents), polyethylene glycol of different molecular weight and glycerol, propylene glycol or more. However, the resin in the intermediate layer has an average molecular weight which is greater than the average molecular weight of the resin in the first or top layer and which is less than the average molecular weight of the water-soluble resin in the second layer. In the present invention the top and middle layer containing film forming material in the form of blend of poly vinyl alcohol and poly vinyl acetate in deferent ratio. While the core layer having water soluble polymer with low molecular weight with low degree of hydrolysis like poly vinyl alcohol. The multilayer degradable films disclosed and claimed herein may be made in accordance with process. The process includes the steps of forming a first dissolve (PVA-GLO50) in water, and then solvent based solution comprising a Water-resistant thermoplastic resin such as polyvinyl acetate dissolve either in methyl ethyl ketone (MEK), or ethyl acetate or acetone. Then blend with polyvinyl alcohol (PVA-GL-05) and PVAc is prepare by mixing both solution of PVA and PVAc in (70:30) ratio. Stir the mixture for land half ours. Here PVA solution itself act ac emulsifying agent and also add 2-3% W/V surface active agent like sodium lauryl sulphate (SLS). Resulting solution become opaque/white. Filter the mixture and allow to stabilize at ambient temperature. The emulsion solution is use for solution of at least one nitrogenous constituent such as urea, urea-formaldehyde condensation product, di ammonium phosphate, ammonium sulphate in addition to the nitrogen water soluble NPK and soil constructing nutrients like zinc sulphate and ferrous sulphate and organic liquid fertilizer. A mixing the above all ingredients the solution is stirring for one hour. The resulting solution is poured on 100 micron polyester film and pass through between two rollers having desired thickness, the casting film dry in oven having temperature of 135° C. for 5-6 minutes depending on thickness of casting film. A second layer or middle layer consist of emulsion solution of PVAc and PVA (173-hot water soluble) with insecticide, fungicide. A relatively thin coating of the second solution i.e., relatively thin film of about 10-15 micron thickness with respect to the thickness of the first cast film on top of the film which was formed from the first aqueous solution. A second aqueous solution is also prepared. The second amalgamated aqueous solution includes a water-soluble synthetic film-forming resin such as a polyvinyl alcohol. However, the average molecular weight of the resin is greater than the average molecular weight of the water-soluble synthetic resin in the first layer. The second aqueous solution also includes at least one nitrogenous constituent and at least one additional nutrient such as a di ammonium phosphate, ammonium sulphate in addition to the nitrogen and water soluble NPK and soil constructing nutrients like zinc sulphate and ferrous sulphate and organic liquid fertilizer. A coating of this second aqueous admixture is poured on dried layer first cast film 100 micron polyester film according above mention process using two roller having adjustable gape between them, i.e., on top of the second water dispersible film and dried to form a multi-layer film with controlled release of nutrients. The thickness of the various layers, concentration of resins, molecular weights, amount and type of nutrients can all be varied to provide a degradable film which is tailored to the needs of a particular crop. The molecular weights of the water-soluble and water-resistant polymer can be varied substantially. For example, the use of polyvinyl alcohols having average molecular weights of from about 14,000 to about 95,000 and poly vinyl acetate having average molecular weights ranging from about 45,000 to about 90,000 are recommended. The third layer or core layer of present invention is comprised of blend of polyvinyl alcohol with starch, glycerol deferent molecular weight of PEG, wetting agent, is casting on above two casted layer using the same method and resulting casting film is dried in oven having temperature 100-135° C. for 5-6 minutes. The thickness of individual layer is 15-20 micron.

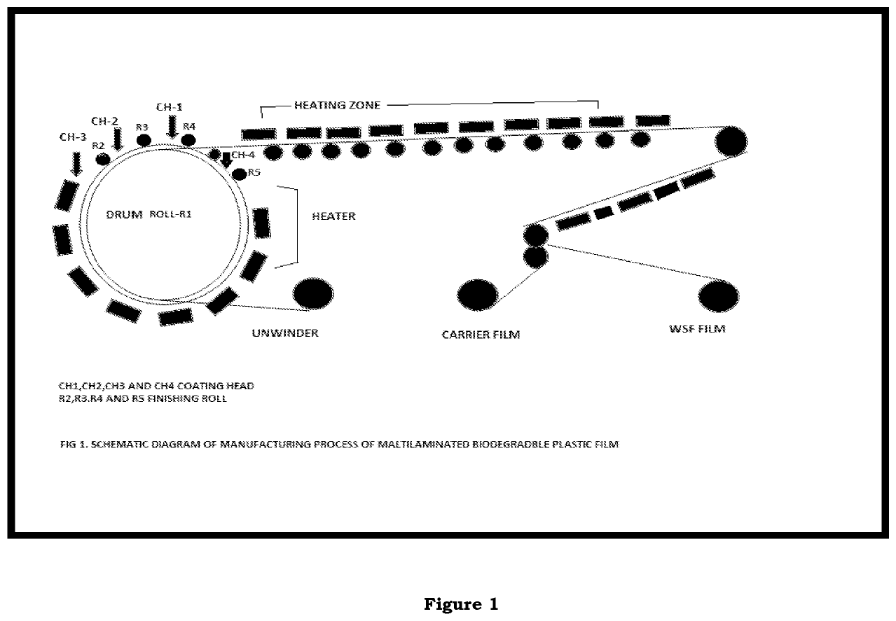

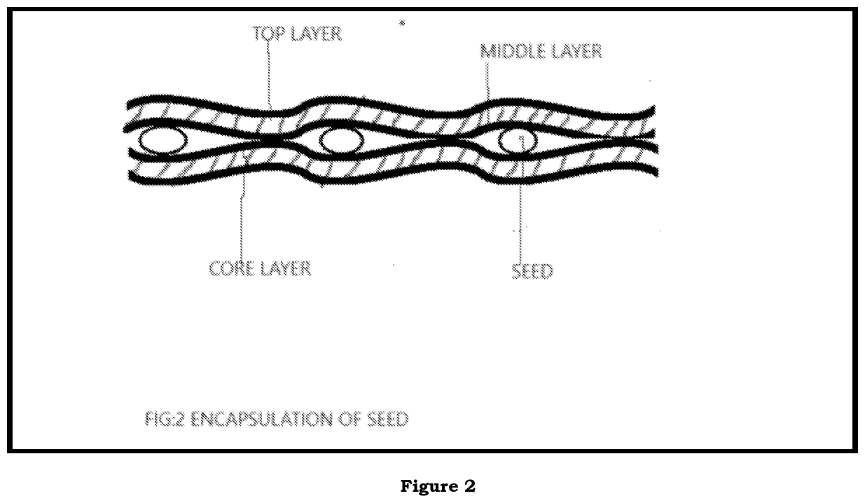

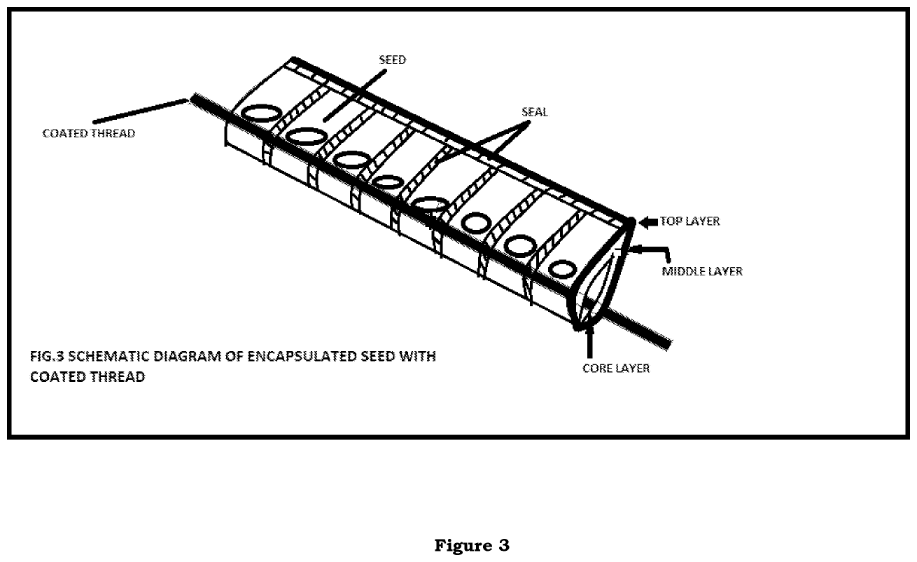

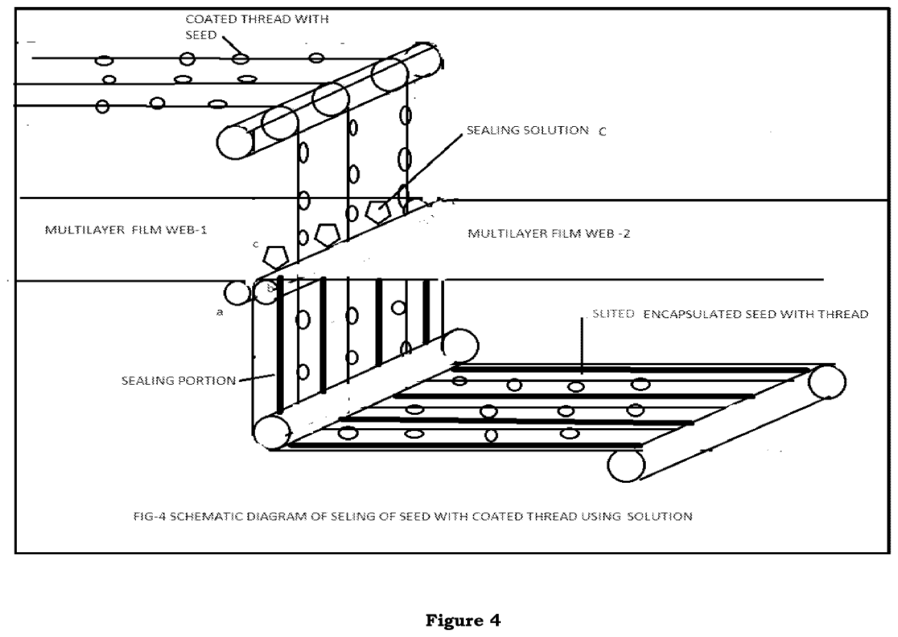

### DESCRIPTION OF DRAWINGS

| | |
|---|---|
| FIG. 1: | Schematic Diagram of Manufacturing Process of Biodegradable |
| | Plastic Film |
| FIG. 2: | Encapsulation of Seed |
| FIG. 3: | Schematic Diagram of Encapsulated Seed with Coated Thread |
| FIG. 4: | Schematic Diagram of Sealing of Seed with Coated Thread |
| | Using Solution |

### DETAILED DESCRIPTION OF THE INVENTION

Some crops need nutrients in three main stages like seed germination, vegetative and flowering for optimal growth and plant production. Such plants need phosphorous and potassium and some nitrogen during the pre-planting or preemergent stage. And during their second stage of growth, i.e., prior to fruiting, such plants require a medium dose of nitrogen and may require some phosphorous and potassium. And then, during the third stage of growth i.e., the flowering or fruiting stage, the plants need a major portion of nitrogen and may need additional amounts of phosphorous and potassium. While other crops such as corn, beans and etc. need nutrients in two main stages. A multi-layer degradable film according to the present invention can be tailored to provide optimal amounts of nutrients during the various stages of plant growth. For example, a preferred embodiment of the present invention includes a water-soluble polymer such as polyvinyl alcohol recommended average molecular weight within the range of about 20,000 to 40,000, Nitrogen, phosphorous and potassium sources such as water soluble NPK, urea, U-F (urea-formaldehyde) condensate product and the like. This layer provides the needed nutrients in the pre-planting or preemergent stage and may also be used to sterilize the soil. The second layer includes a water-soluble polymer such as a polyvinyl alcohol, or methyl cellulose or hydroxyethyl cellulose. However, the water-soluble polymer in the second layer has a higher average molecular weight recommended range from about 40,000 to about 95,000, generally hot water soluble poly vinyl alcohol. The second layer also includes a source of nitrogen such as a urea-formaldehyde condensate product and may include a source of phosphorous and potassium in the form of soluble NPK (19:19:19) and organic liquid fertilizer. The second layer is thin film of water-resistant polymer such as polyvinyl acetate blend with polyvinyl alcohol. This second layer provides the nutrients which are needed during the growth stage of the crop, i.e., prior to fruiting. The third or bottom layer includes a water-soluble polymer such as a polyvinyl alcohol having a relatively low molecular weight and include glycerol, ethylene-glycol having deferent molecular weight, starch, Propylene glycol, wetting agents, insecticides, pesticides, and fungicides. The nutritional multi-layer film as described above is an integral composite that is relatively strong, flexible and which has a high degree of clarity. Other additives can of course be incorporated in the various layers. For example, a nitrification inhibitor such as thiourea, others can be used with urea to slow the rate of release of nitrogen. However, when a urea-formaldehyde condensate is used as a source of nitrogen, a nitrification inhibitor is not usually needed since thiourea-formaldehyde condensate normally provides the desired slow release properties. According to the present preferred embodiment of the invention there are multiple major steps involved in the preparation of a multi-layer controlled release multi nutrients degradable film that can be tailored to meet the needs of a specific crop. For example, the top layer which is the slowest dissolving may be made of 20 to 25% water soluble polymer such as polyvinyl alcohol with a recommended molecular weight ranging from about 72,000 to 100,000 and a degree of hydrolysis ranging from about 97 to about 98%. The top layer also includes from about 2-10% of a water-resistant resin such as poly vinyl acetate in the form of blend with poly vinyl alcohol (30:70 ratio) with various nutrients containing nitrogen (N), phosphorous (P) and potassium (K) salts in form of water soluble NPK (19:19:19) in the range of 0 to 5% w/v. The second layer may contain 20-25% of a water-soluble polyvinyl alcohol with medium molecular weight recommended range from 22,000 to about 72,000, and 10-15% higher molecular weight ranging from 72,000 to 95,000, and about 2-10% of water resistant resin such as polyvinyl acetate and various salts. The second layer includes from 0-5% w/v U-F, 0-4% w/v water soluble NPK and 2-6% v/v organic liquid fertilizer. The third or bottom layer is the fastest dissolving layer and consists of 20 to 25% of low molecular weight polyvinyl alcohol with recommended molecular weights ranging from 15,000 to 22,000 and glycerol, ethylene-glycol having deferent molecular weight, starch, propylene glycol, wetting agents, the source of nitrogen in the above composite film is mainly urea and urea-formaldehyde poly condensates.

On the other hand, when urea-formaldehyde is added there is no need for nitrification inhibitors to be added because urea-formaldehyde is prepared in such a way as to provide slow release characteristics. In addition, according to our preparation procedure the urea-formaldehyde acts as a binder between the various layers of the composite film. Thus, the urea-formaldehyde used in the present invention is prepared according to the following procedure. A solution of urea is prepared in distilled water of about (120 gm in 500 ml water) and keep solution under continues agitation for 30 min, then add about 30 gm of formaldehyde solution, stir the mixture of 10 min. and then add 1-2 drops of concentrated HCL/H2SO4, stirred the mixture until white precipitation observed. Filter the products and wash with water several time to remove unreacted reactants and acid, dried the reaction product in oven maintain at 70° C. for 2-3 hrs. The molar ration of urea:formaldehyde may be (2:1). Another way is to form condensate product of urea and formaldehyde is dissolve polyvinyl alcohol 25% in water after complete dissolution add urea 10% W/V and formaldehyde solution of 8% V/V, reflux the reaction mixture under continues agitation at 70-80° C. temperature for 30-45 minutes. Stop the heating and agitation before jell formation. Filter the solution and allow to cool at room temperature. The preparation of the multi-layer composite film requires several steps. The film is made by solution casting using conventional casting method (FIG. 1), roller R1 (FIG. 1) is drum-based method. In this method casting solution is poured direct on finished drum surface without any carrier. Casting solution may be pass through two steel rolls having gape adjusting facility on one roll. The coating GSM/Thickness is control by the viscosity of solution and gape between two roll i.e. master roll and finishing roll. The thickness of film varies from about 35-45 micron depending upon the shape and size of the seed. Any coating thickness over the minimum will increase the cost of materials used and of the coating procedure.

Film Formation:

All the deferent layer may be cast in single run by using deferent coating head mountain at deferent place on drum as shown in FIG. 1. Inside drum temperature is ranging from 80-90° C. Higher temperature causes bubble on surface of the cast film. The temperature of the heating oven around the drum may be ranging from 125-140° C. Same machine may be use for casting the film using carrier material. In this method casting solution of deferent batch may be poured from the coating head (FIG. 1 CH1, CH2, CH3, CH4) on the plan surface of carrier material. Coating head has facility to control the flow of batch solution by moving/adjusting the gap between to blade provide in coating head. Carrier material may be polyester film, poly coated film, fabric, metalize paper, metalize polyester film, coated fabric or others. Multilayer film may be produced by online or offline method. Here, R2, R3, R4 and R5 are the finishing roll While CH1, CH2, CH3 and CH4 are coating Head Mountain on drum roll R1.

Batch Formation:
a) May be made by adding 25% polyvinyl alcohol (GL05 from Ghosenol), and 12% polyvinyl alcohol (173 Kurarey) in deferent vessels with distilled water and heating the mixture with continuous stirring at 60-95° C. to prevent gel formation and to avoid undissolved particle of polyvinyl alcohol, granules/powder is slowly added in cold water and after completing addition, increase the temperature until a clear solution is obtained. Wetting agent anionic surfactant like sodium lauryl sulphate (SLS) or nonionic surfactant alcohol ethoxylate, Triton x-100, Triton x-114 Brig 35 or other may be use in 1-2% W/V. The required amounts of additives, such as glycerol (2-5% W/V), polyethylene glycol (2-10% W/V) of different molecular weight i.e. 400 (3-6% W/V) and 6000 (2-10% W/V), soluble starch (1-8% W/V) are added to the polymeric solution. The clear solution is then filtered and cooled to 30-40° C. Thus two deferent solution is of poly vinyl alcohol is formed.
b) Corn starch solution is prepared by using dissolving 10% starch in water by slowing adding starch in cold water and then increasing the temperature up to 90° C. with continuous stirring for 1 hr. until clear solution. The clear solution is then filtered and cooled to 30-40° C.
C) Blend Preparation
   For the preparation of Starch with poly vinyl alcohol, starch of about 10% is added in distilled water. And add gradually starch powder with continues agitation for 30 min, and then increase the temperature of the mixture up to 90° C. for 1 hr. Use solution of poly vinyl alcohol (GL05) and Starch solution in 90:10 ratio in reaction vessel for stirring and heating at 90 deg. cell. For 1 hr. after that filter the solution and cool at room temp. Add other additives like such as glycerol (2-5% W/V), polyethylene glycol of different molecular weight i.e. 400 (3-6% V/V) and 6000 (2-10% W/V), soluble starch (1-8% W/V), propylene glycol (2-6% V/V) are added to the polymeric blend solution. Again stir solution for 30 min and then filtered and cooled to 30-40° C.
d) Solution of polyvinyl acetate is prepared by adding 100 grams of polyvinyl acetate with recommended molecular weight ranging from 40,000 to 100,000 to a reaction vessel containing 1000 ml. of ethyl acetate. The reaction mixture is refluxed until all of the polymer is dissolved. Then, the reaction solution is cooled to room temperature with viscosities ranging from 20-25 sec. (measured with 4-B CUP when measured at 25° C.)
e) blend of polyvinyl acetate and polyvinyl alcohol is formed by mixing solution of (d) and solution of (a) in reaction vessel, reflux the reaction mixture with adding 0-1% surface active agent SLS for 1 hr. and filter then cool at room temperature. The mixing ration PVA:PVAc may be (70:30).
f) solution of all active ingredients 1-20% is dissolve in water and use as per require in solution of (e) and (c).

The Multi-Layer Film is Cast as Follows:

A thin coating of GL05 water soluble polymer solution including all ingredients is poured onto a 100 micron polyester film use as carrier material and pass between two rolls. Thickness of the casting film is monitor by adjusting the gap between two rolls. The thickness of this layer is controlled by the viscosity of the casting solution and gape between two rolls. The carrier film passes from heating chamber for 3-4 min. The cast film is dried and the nutritional solution of the middle layer is cast on top of the first dried the film. And, again the thickness of this layer is controlled by the gap between two roller and viscosity of blending solution. The blending ratio of PVAc/PVA is (30:70). Then, after drying, a second layer of a nutritional solution, a third coating is cast on top of the second dried layer. The coated layer is pass from oven to compete drying. Thus, the produce films that are clear, flexible with good mechanical properties. (TABLE: 2)

Seed Sowing Procedure:

Seeds of deferent crops can be sowing by using this invented multilayered biodegradable film.

Encapsulation of seeds are carried out by any convention converting machine, the main important thing in encapsulation is the surface in contact with seed will be bottom layer of multilayer film. FIG. 2). During encapsulation of seed a bio-degradable thread/string may be introduce with seed. This thread is precoated with solution of bottom layer and dried before use. Encapsulation of thread with seeds increase the strength of film. FIG. 3). Another way of encapsulation of seeds with coated biodegradable thread is shown in FIG. 4, where the coated thread in semi dry form is pass from seed containing tray, because of sticky properties of semi dry thread the seeds are stick on the surface of the thread, dry the coated thread by blowing hot air having temperature around 40-50 deg. Cell. Then the coated thread with seeds pass between two laminated web of multilayer biodegradable film passing from two laminating roll (a and b) to prevent the damage of seed by pressing roll, one laminating roll (b) is covered with foam type material while other is having Teflon coated surface. Sealing of two laminated web of laminated biodegradable film may be carried out by applying solution of water and acetone using pen having flat nib of 1-2 cm width (FIG. 4, c). The mixing ratio of water:acetone may be (10:90). The resulting sealed film the pass from hot air having temp. 40-50 deg. Cell. Resulting film may be slit on line or off line as per end use. The encapsulated seeds are sow in soil with depth of about 2-2.5 inch, the moisture of soil may be 30-35%. For comparation study seeds without encapsulation are also sow. Experiment of germination is carried out in room having temperature ranging from 22-28° C. and relative humidity 55-65%. The result of germination and plant growth with and without film for various seeds are shown in Table-1.

TABLE-1

| | | | | Plant | | | |
|---|---|---|---|---|---|---|---|
| | | Germination | | Height(cm) | | Plant Height(cm | |
| | | Rate(%) | | After 7 Days | | After 14 Days | |
| Sr. | | With | Without | With | Without | With | Without |
| No. | Seeds | Film | Film | Film | Film | Film | Film |
| 1 | COWPEA | 95 | 90 | 15 | 12.3 | 18 | 14 |
| | (CHOLI) | | | | | | |
| 2 | MOONG | 96 | 90 | 17 | 14.3 | 19.5 | 16 |
| 3 | PIGEON PEA | 80 | 60 | 7 | 5.3 | 17 | 12 |
| | (TUVER) | | | | | | |
| 4 | VATANA | 93 | 66 | 4 | 2 | 27 | 18 |
| | (PEAS) | | | | | | |
| 5 | VAL (INDIAN | 95 | 87 | 11 | 9 | 26 | 19 |
| | BEAN) | | | | | | |
| 6 | RAJMA | 94 | 85 | 7 | 6 | 26 | 22 |
| | (FRENCH | | | | | | |
| | BEANS) | | | | | | |
| 7 | DESI CHANA | 90 | 75 | 9 | 8 | 31 | 26 |
| 8 | KABULI | 85 | 70 | 2.3 | 1.6 | 29 | 17 |
| | CHANA | | | | | | |
| 9 | WHEAT | 92 | 80 | 16 | 12 | 26 | 18 |
| 10 | MAIZE | 90 | 69 | 12 | 7 | 29 | 19 |
| 11 | PADDY | 98 | 74 | 10 | 8 | 11 | 8.3 |

TABLE 2

| | | TOP | MIDDLE | CORE | MULTI |
|---|---|---|---|---|---|
| Properties | Units | LAYER | LAYER | LAYER | LAYER |
| % Elongation At | % | 153 | 45 | 126 | 111 |
| Break | | | | | |
| Tensile Strength | kg/cm · sq. | 136 | 210 | 264 | 236 |
| Peak Load | kg/cm · sq. | 0.68 | 1.05 | 0.66 | 2.36 |
| Solubility in | sec | | | 10 | |
| water at 22° C. | | | | | |
| COF | | | | | 0.233 |
| OTR | | | | | 1.287 |
| Thickness | micron | 20 | 20 | 15 | 45 |

We claim:

1. A composite, bio-degradable agricultural film which comprises:
a) a first layer formed from a water-soluble resin and at least one releasable form of nitrogen admixed therein and at least one releasable plant nutrient in addition to nitrogen for providing an initial amount of nutrients to a plant during the germination stage and early emergent stage,
b) a second layer formed as an adherent coating on said first layer, said second layer comprising a Physical blend of water-soluble synthetic PVOH and PVAc water resisting resin having an average molecular weight which is greater than the average molecular weight of the water soluble synthetic resin in said first layer and at least one releasable form of nitrogen admixed therein, and a water resistant polymer to retard the degradation rate of said second layer and to slow the rate of release of said nitrogen so that said second layer provides needed nutrients to a plant during the later stage of its growth.

2. A composite, degradable, agricultural film as claimed in claim 1 in which the water-soluble synthetic resin in said first layer is a polyvinyl alcohol having an average molecular weight within the range of about 15,000 and about 72,000, and the water-soluble synthetic resin in said second layer is a polyvinyl alcohol having an average molecular weight within the range of about 49,000 and 100,000 and wherein the water-resistant polymer in said second layer is a polyvinyl acetate having an average molecular weight within the range of about 45,000 to about 140,000.

3. A multilayer bio degradable composite, agricultural film which comprises: (a) a first layer formed from a water-soluble synthetic resin and at least one releasable form of nitrogen admixed therein and at least one releasable plant nutrient in addition to nitrogen for providing an initial amount of nutrients to a plant during the preemergent and early emergent stage; (b) a second layer formed as an adherent coating on said first layer, said second layer comprising a water-soluble synthetic resin having an average molecular weight which is greater than the average molecular weight of the water soluble synthetic resin in said first layer and at least one releasable form of nitrogen admixed therein, for providing the nutrients during the growth stage of the plant; and (c) a third layer formed as an adherent coating on said second layer, said third layer comprising a water-soluble synthetic resin having an average molecular weight which is less than the average molecular weight of the water soluble synthetic resin in said second layer.

4. A multilayer bio degradable composite, degradable, agricultural film, as claimed in claim 3 in which said Second layer includes at least one releasable plant nutrient in addition to nitrogen.

5. A multilayer bio degradable composite, degradable, agricultural film, as claimed in claim 4 in which said top layer includes at least one releasable plant nutrient in addition to nitrogen.

6. A multilayer bio degradable composite, degradable, agricultural film, as claimed in claim 3 in which said second layer includes a blend of water soluble and water-resistant polymer to retard the degradation rate of said second layer.

7. A multilayer bio degradable composite, degradable, agricultural film, as claimed in claim 6 in which said water-soluble resin in each of said layers is polyvinyl alcohol.

8. A multilayer bio degradable composite, degradable, agricultural film, as claimed in claim 7 in which the average molecular weight of the polyvinyl alcohol in said first layer ranges from about 15,000 to about 22,000.

9. A multilayer bio degradable composite, degradable, agricultural film, as claimed in claim 8 in which the average molecular weight of the polyvinyl alcohol in said second layer ranges from about 22,000 to about 72,000.

10. A multilayer bio degradable composite, degradable, agricultural film, as claimed in claim 9 in which said average molecular weight of the polyvinyl alcohol in said third layer ranges from about 72,000 to about 95,000.

11. A multilayer bio degradable composite, degradable, agricultural film, as claimed in claim 3 in which said water-resistant polymer is polyvinyl acetate.

12. A multilayer biodegradable composite, degradable, agricultural film, as claimed in claim 6 in which said water-resistant polymer is polyvinyl acetate and in which the source of nitrogen is a urea formaldehyde condensate with a formaldehyde to urea ratio of about 1:2.

13. A multilayer biodegradable composite, degradable, agricultural film, as claimed in claim 3 in which said first layer includes a source of phosphorous and potassium.

14. A multilayer biodegradable composite, degradable, agricultural film, as claimed in claim 13 in which said source of nitrogen is selected from the group consisting of urea and urea-formaldehyde poly condensates.

15. A multilayer biodegradable composite, degradable, agricultural film, as claimed in claim 14 in which said source of nitrogen is urea and in which said first layer includes a nitrification inhibitor.

16. A multilayer biodegradable composite, degradable, agricultural film, as claimed in claim 13 in which said plant nutrient in addition to nitrogen is water soluble NPK.

17. A multilayer biodegradable composite, degradable, agricultural film, as claimed in claim 3 in which said first layer includes starch and a fumigant.

18. A multilayer biodegradable composite, degradable, agricultural film, as claimed in claim 12 in which said polyvinyl acetate has an average molecular weight within the range of about 45,000 to about 190,000.

19. A multilayer biodegradable composite, degradable, agricultural film, as claimed in claim 13 in which said second layer includes a urea-formaldehyde poly condensate and di ammonium phosphate. And ammonium sulfate.

20. A multilayer biodegradable composite, degradable, agricultural film, as claimed in claim 19 in which second layer includes corn starch.

21. A multilayer biodegradable composite, degradable, agricultural film, as claimed in claim 19 in which said second layer includes an insecticide.

22. A multilayer biodegradable composite, degradable, agricultural film, as claimed in claim 19 in which said second layer includes a pesticide.

23. A multilayer biodegradable composite, degradable, agricultural film, as claimed in claim 13 in which said third layer includes a source of phosphorous and potash and soil constructing materials like zinc and ferrous.

24. A multilayer biodegradable composite, degradable, agricultural film, as claimed in claim 23 in which said third layer includes ethylene-glycol having molecular weight 400 and 6000.

25. A multilayer biodegradable composite, degradable, agricultural film, as claimed in claim 23 in which said third layer includes propylene glycol.

26. A multilayer biodegradable composite, degradable, agricultural film, as claimed in claim 23 in which said third layer includes glycerol.

27. A multilayer biodegradable composite, degradable, agricultural film, as claimed in claim 23 in which said third layer includes wetting agent like non-ionic surfactant e.g. Sodium lauryl sulphate, Triton-X, 100, TRITON-X-114, brig 35 etc.

28. A multilayer biodegradable composite, degradable, agricultural film, as claimed in claim 23 in which said third layer includes starch.

29. A multilayer biodegradable composite, degradable, agricultural film, as claimed in claim 23 in which said third layer includes a material selected from the group consisting of insecticides, neem base insecticides, weedicide, pesticides, fungicides and mixtures thereof.

30. A multilayer biodegradable composite, degradable, agricultural film, as claimed in claim 2 in which said top or first layer includes about 2-5% W/V soluble NPK (19-19-19) (Basfoliar, Germany) has a tensile strength of about (254) Kilograms per square centimeter, and elongation at break of about (116%), about 13.0% moisture, and a thickness of about 20 micron.

31. A multilayer biodegradable composite, degradable, agricultural film, as claimed in claim 3 in which said second or middle layer includes about 2-5% W/V organic liquid fertilizer has a tensile strength of about (210) Kilograms per square centimeter, and elongation at break of about (45%), about 5.5% moisture, and a thickness of about 20 micron.

32. A multilayer biodegradable composite, degradable, agricultural film, as claimed in claim 10 in which said core or bottom layer includes about 1-10% W/V corn starch and 0-5% V/V glycerol has a tensile strength of about (264) Kilograms per square centimeter, and elongation at break of about (126%), about 9.35% moisture, and a thickness of about 20 micron.

33. A multilayer biodegradable composite, degradable, agricultural film, as claimed in claim 1 in which the water-soluble synthetic resin in said first layer is poly vinyl acetate blend with polyvinyl alcohol (10:90 ratio).

34. A multilayer biodegradable composite, degradable, agricultural film, as claimed in claim 1 in which the water-soluble synthetic resin in said second layer is a poly vinyl acetate blend with polyvinyl alcohol (30:70 ratio).

35. A multilayer biodegradable composite, degradable, agricultural film, as claimed in claim 10 in which said bottom layer includes between about 5-10% W/V starch, 0-8% V/V glycerol, 0-6% V/V propylene glycol, 0-4% V/V poly ethylene glycol 400, 0-5% W/V polyethylene glycol 6000 and 0-2% sodium lauryl sulphate, the thickness of such film may be 15-20 micron and polyvinyl alcohol resins in each of said layers have a degree of hydrolysis ranging from about 86 to about 89%.

36. A method for preparing a clear multilayer multi-nutrients containing biodegradable film which comprises the steps of: (a) forming a blend of PVAc and PVOH solution comprising a water-resistant thermoplastic resin and an organic solvent and nitrogen releasing agents wetting agent and soil constructing agent and plasticizer; (b) casting a film from above said blend (c) drying said film; and (d) forming a blend of water soluble synthetic film-forming resin and water resistance polymer, and at least one nitrogenous constituent which functions as a releasable source of nitrogen and nitrogen releasing agents wetting agent and soil constructing agent and plasticizer (e) coating the dried film resulting from step b with a layer of said aqueous admixture, (f) drying the coating applied in step d; (g) casting the film of solution consisting of polyvinyl alcohol with wetting agent, plasticizer, sealing agent, starch on step e.

37. A method for preparing a clear multi-layer nutrient containing degradable mulch film in accordance with claim 36 wherein the water-resistant thermoplastic resin used in step (a) is selected from the group consisting of polyvinyl acetate, ethylene/acrylic acid copolymer, ethylene/ethyl acrylate copolymer and mixtures thereof.

38. A method for preparing a clear multi-layer nutrient containing degradable film in accordance with claim 37 wherein the water-resistant thermoplastic resin is a polyvinyl acetate having an average molecular weight ranging from about 40,000 to about 190,000.

39. A method for preparing a clear multi-layer multi nutrients containing degradable film in accordance with claim 36 wherein the water-soluble synthetic film forming resins in steps (c) and (j) are selected from the group consisting of blend of polyvinyl alcohol with polyacrylamide and blend of polyvinyl alcohol with polyacrylic acid.

40. A method for preparing a clear multi-layer nutrient containing degradable film in accordance with claim 33 wherein the water-soluble synthetic film forming resins in steps (c), (e) and (g) are polyvinyl alcohol.

41. A method for preparing a clear multi-layer nutrient containing degradable mulch film in accordance with claim 34 wherein the water-resistant thermoplastic resin is a polyvinyl acetate having an average molecular weight ranging from about 40,000 to about 190,000 and wherein the water-soluble synthetic film forming resins in steps (d) and (j) are polyvinyl alcohol having average molecular weights between about 25,000 and about 95,000.

42. A method for preparing a clear multi-layer nutrient containing degradable film in accordance with claim 36 wherein said first, second, and third layer; the poly vinyl alcohol the degree of hydrolysis is ranging from 86-98%; this water-soluble polymeric material may be hot water soluble or cold water soluble depending on the degree of hydrolysis and molecular weight higher the molecular weight having less solubility in cold water.
